(19) United States
(12) Patent Application Publication
(10) Pub. No.: US 2021/0149397 A1
(43) Pub. Date: May 20, 2021

(54) APPARATUS AND METHOD FOR CONTROLLING THE USER EXPERIENCE OF A VEHICLE

(71) Applicant: LG ELECTRONICS INC., Seoul (KR)

(72) Inventors: Ahyoung SHIN, Gyeonggi-do (KR); Yong Hwan LEE, Gyeonggi-do (KR); Jongyeop LEE, Seoul (KR)

(21) Appl. No.: 16/798,919

(22) Filed: Feb. 24, 2020

(30) Foreign Application Priority Data
Nov. 15, 2019 (KR) 10-2019-0146884

(51) Int. Cl. G05D 1/00; G06K 9/00

(52) U.S. Cl. CPC G05D 1/0088; G01C 21/34; G06K 9/00791

(57) ABSTRACT

Disclosed is a method of operating a vehicle user experience (UX) control apparatus by executing an artificial intelligence (AI) algorithm and/or a machine learning algorithm in a 5G communication environment constructed for an Internet of things (IoT) network. The vehicle UX control method includes monitoring the interior of a vehicle to recognize an occupant, determining the type of occupant, providing a user interface corresponding to the occupant based on the type of occupant, and performing a process corresponding to a user request input by the occupant through the user interface.

### CROSS-REFERENCE TO RELATED APPLICATION

This present application claims the benefit of priority to Korean Patent Application No. 10-2019-0146884, entitled “APPARATUS AND METHOD FOR CONTROLLING THE USER EXPERIENCE OF A VEHICLE,” filed on Nov. 15, 2019, in the Korean Intellectual Property Office, the entire disclosure of which is incorporated herein by reference.

### BACKGROUND

### 1. Technical Field

The present disclosure relates to an apparatus and method for controlling a user experience (UX) for a vehicle, which provide a UX that reacts differently based on the type of occupant of an autonomous vehicle upon receiving a request from the occupant.

### 2. Description of Related Art

In the near future, autonomous vehicles will bring a lot of changes to the lifestyles of people. Many global automakers and information technology (IT) companies are currently researching and developing autonomous vehicles. However, most research and development focuses mainly on safe autonomous driving, rather than on the design of autonomous vehicles.

User experience (UX) refers to the process and results of analyzing the various experiences of users while the users use a vehicle so that a specific process may be performed more conveniently and efficiently. In other words, UX may encompass the design of an interface and a set of processes for facilitating the use of a vehicle through in-depth analysis of the characteristics of users.

### SUMMARY OF THE INVENTION

An aspect of the present disclosure is to provide a user experience (UX) that reacts differently based on the type of occupant of an autonomous vehicle upon receiving a request from the occupant.

Another aspect of the present disclosure is to perform a different process depending on the type of occupant even when an occupant inputs the same request as another occupant.

Still another aspect of the present disclosure is to perform an occupant authentication process in order to give only an authenticated occupant the authority to control a vehicle.

Still another aspect of the present disclosure is to provide a customized user interface based on the access authority of each occupant depending on the type of each occupant.

Still another aspect of the present disclosure is to determine the type of occupant using a camera and a sensor module provided in the interior of a vehicle, and to additionally determine the type of occupant based on an occupant type determination probability value.

The present disclosure is not limited to what has been described above, and other aspects not mentioned herein will be apparent from the following description to one of ordinary skill in the art to which the present disclosure pertains. Further, it is understood that the objects and advantages of the present disclosure may be embodied by the means and a combination thereof in claims.

In accordance with an aspect of the present invention, the above and other objects can be accomplished by the provision of a method of controlling a user experience (UX) for a vehicle, the method including providing a UX that reacts differently based on the type of occupant of an autonomous vehicle upon receiving a request from the occupant.

Specifically, the method may include monitoring the interior of a vehicle to recognize an occupant, determining the type of occupant, and providing a user interface corresponding to the occupant based on the type of occupant.

The method may further include performing a process corresponding to a user request input by the occupant through the user interface.

According to the vehicle UX control method according to the embodiment of the present disclosure, when an occupant of an autonomous vehicle inputs a user request, a process may be performed differently depending on the type of occupant or depending on whether the occupant is an authenticated occupant, and a customized user interface based on the access authority of the occupant may be provided.

In addition, in order to implement the present disclosure, there may be further provided other methods, other systems, and a computer-readable recording medium having a computer program stored thereon to execute the methods.

Other aspects and features in addition as those described above will become clear from the accompanying drawings, claims, and the detailed description of the present disclosure.

According to the embodiments of the present disclosure, when an occupant of an autonomous vehicle inputs a user request, a process is performed differently depending on the type of occupant or depending on whether the occupant is an authenticated occupant, and a customized user interface based on the access authority of the occupant is provided, thereby increasing the user's satisfaction with the product.

In addition, an occupant authentication process is performed to give a vehicle control authority only to an authenticated occupant, thereby preventing the control authority from being provided to an occupant who is not responsible for the control.

In addition, respectively different UXs are provided based on various types of occupants of an autonomous vehicle, thereby increasing the product reliability.

In addition, a customized process and content are provided to a child or an animal through corresponding user interfaces, thereby allowing the child or the animal to focus on the content in the vehicle, and thus preventing the occurrence of unexpected situation caused by the child or the animal during operation of the vehicle.

In addition, even when an occupant changes his/her position in the vehicle, the same user interface as that before the position change is provided to the occupant, and reproduction of the same content continues, thereby improving convenience.

In addition, the type of occupant is determined based on a machine-learning-based learning model, which is trained to determine the type of occupant, thereby improving the performance of a vehicle UX provision system.

In addition, since an optimal UX is provided through 5G network-based communication, it is possible to rapidly process data, thereby further improving the performance of a vehicle UX provision system.

In addition, although a vehicle UX control apparatus is a standardized product that is mass-produced, a user is capable of using the vehicle UX control apparatus as a personalized apparatus, thereby obtaining the effects of a user-customized product.

The effects of the present disclosure are not limited to those mentioned above, and other effects not mentioned may be clearly understood by those skilled in the art from the above description.

### BRIEF DESCRIPTION OF THE DRAWINGS

The above and other aspects, features, and advantages of the present disclosure will become apparent from the detailed description of the following aspects in conjunction with the accompanying drawings, in which:

FIG. 1 is a diagram illustrating a user interface (UX) control system environment of an artificial intelligence (AI) system-based vehicle including a cloud network, according to an embodiment of the present disclosure;

FIG. 2 is a diagram schematically illustrating a communication environment of a vehicle UX control system according to an embodiment of the present disclosure;

FIG. 3 is a schematic block diagram of the vehicle UX control system according to an embodiment of the present disclosure;

FIG. 4 is a diagram illustrating an example of the basic operation of an autonomous vehicle and a 5G network in a 5G communication system;

FIG. 5 is a diagram illustrating an example of the application operation of an autonomous vehicle and a 5G network in a 5G communication system;

FIGS. 6 to 9 are diagrams illustrating an example of the operation of an autonomous vehicle using 5G communication;

FIG. 10 is a schematic block diagram of a processor according to an embodiment of the present disclosure;

FIG. 11 is an exemplary process table illustrating the performance of functions depending on the type of occupant according to an embodiment of the present disclosure;

FIG. 12 is a flowchart illustrating a vehicle UX control method according to an embodiment of the present disclosure; and

FIG. 13 is a flowchart illustrating a vehicle UX control method based on access authority according to an embodiment of the present disclosure.

### DETAILED DESCRIPTION

The advantages and features of the present disclosure and methods to achieve them will be apparent from the embodiments described below in detail in conjunction with the accompanying drawings. However, the description of particular exemplary embodiments is not intended to limit the present disclosure to the particular exemplary embodiments disclosed herein, but on the contrary, it should be understood that the present disclosure is to cover all modifications, equivalents and alternatives falling within the spirit and scope of the present disclosure. The embodiments disclosed below are provided so that this disclosure will be thorough and complete and will fully convey the scope of the present disclosure to those skilled in the art. In the interest of clarity, not all details of the relevant art are described in detail in the present specification in so much as such details are not necessary to obtain a complete understanding of the present disclosure.

The terminology used herein is used for the purpose of describing particular example embodiments only and is not intended to be limiting. It must be noted that as used herein and in the appended claims, the singular forms “a,” “an,” and “the” include the plural references unless the context clearly dictates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. Furthermore, these terms such as “first,” “second,” and other numerical terms, are used only to distinguish one element from another element. These terms are generally only used to distinguish one element from another.

A vehicle described herein may be a concept including an automobile and a motorcycle. Hereinafter, the vehicle will be exemplified as an automobile.

The vehicle described in the present specification may include, but is not limited to, a vehicle having an internal combustion engine as a power source, a hybrid vehicle having an engine and an electric motor as a power source, and an electric vehicle having an electric motor as a power source.

Hereinafter, embodiments of the present disclosure will be described in detail with reference to the accompanying drawings. Like reference numerals designate like elements throughout the specification, and overlapping descriptions of the elements will not be provided.

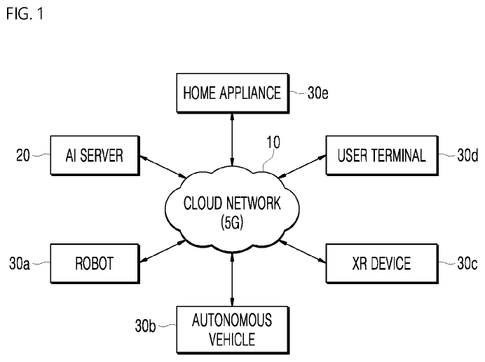

FIG. 1 is a diagram illustrating a user interface (UX) control system environment of an artificial intelligence (AI) system-based vehicle including a cloud network according to an embodiment of the present disclosure.

Referring to FIG. 1, the vehicle UX control system environment may include an AI server 20, a robot 30a, a self-driving vehicle 30b, an XR device 30c, a user terminal 30d or a home appliance 30e, and a cloud network 10. At this time, in the vehicle UX control system environment, at least one of the AI server 20, the robot 30a, the self-driving vehicle 30b, the XR device 30c, and the user terminal 30d or the home appliance 30e can be connected to the cloud network 10. Here, examples such as the robot 30a, the self-driving vehicle 30b, the XR device 30c, the user terminal 30d or the home appliance 30e to which the AI technology is applied may be referred to as “AI devices 30a to 30e.”

The robot 30a may refer to a machine which automatically handles a given task by its own ability, or which operates autonomously. In particular, a robot having a function of recognizing an environment and performing an operation according to its own judgment may be referred to as an intelligent robot. Robots 30a may be classified into industrial, medical, household, and military robots, according to the purpose or field of use.

The self-driving vehicle 30b refers to a vehicle which travels without manipulation of a user or with minimal manipulation of the user, and may also be referred to as an autonomous-driving vehicle. For example, autonomous driving may include a technology in which a driving lane is maintained, a technology such as adaptive cruise control in which a speed is automatically adjusted, a technology in which a vehicle automatically drives along a defined route, and a technology in which a route is automatically set when a destination is set. In this case, an autonomous vehicle may be considered as a robot with an autonomous driving function.

The XR device 30c refers to a device using extended reality (XR), which collectively refers to virtual reality (VR), augmented reality (AR), and mixed reality (MR). VR technology provides objects or backgrounds of the real world only in the form of CG images, AR technology provides virtual CG images overlaid on the physical object images, and MR technology employs computer graphics technology to mix and merge virtual objects with the real world. XR technology may be applied to, for example, a head-mounted display (HMD), a head-up display (HUD), a mobile phone, a tablet PC, a laptop computer, a desktop computer, a TV, and a digital signage. A device employing XR technology may be referred to as an XR device.

The user terminal 30d may access a vehicle UX control system application or a vehicle UX control system site, and may receive a service for operating or controlling the vehicle UX control system through an authentication process. In the present embodiment, the user terminal 30d that has completely undergone the authentication process may operate and control a vehicle UX control system 1. In the present embodiment, the user terminal 30d may be a desktop computer, a smartphone, a notebook, a tablet PC, a smart TV, a cell phone, a personal digital assistant (PDA), a laptop, a media player, a micro server, a global positioning system (GPS) device, an electronic book terminal, a digital broadcast terminal, a navigation device, a kiosk, an MP3 player, a digital camera, a home appliance, and other mobile or immobile computing devices operated by the user, but is not limited thereto. In addition, the user terminal 30d may be a wearable terminal having a communication function and a data processing function, such as a watch, glasses, a hair band, and a ring. The user terminal 30d is not limited thereto. Any terminal that is capable of performing web browsing may be used without limitation.

The home appliance 30e may include any one of all electronic devices provided in a home. In particular, the home appliance 30e may include a terminal capable of implementing, for example, voice recognition and artificial intelligence, and a terminal for outputting at least one of an audio signal and a video signal. In addition, the home appliance 30e may include various home appliances (for example, a washing machine, a drying machine, a clothes processing apparatus, an air conditioner, or a kimchi refrigerator) without being limited to specific electronic devices.

The cloud network 10 may include part of the cloud computing infrastructure or refer to a network existing in the cloud computing infrastructure. Here, the cloud network 10 may be constructed by using the 3G network, 4G or long term evolution (LTE) network, or a 5G network. That is, the devices 30a to 30e and 20 that constitute the vehicle UX control system environment may be connected to one another via the cloud network 10. In particular, each individual device (30a to 30e, 20) may communicate with each other through a base station, but may also communicate directly to each other without relying on the base station.

The cloud network 10 may include, for example, wired networks such as local area networks (LANs), wide area networks (WANs), metropolitan area networks (MANs), and integrated service digital networks (ISDNs), or wireless networks such as wireless LANs, CDMA, Bluetooth, and satellite communication, but the scope of the present disclosure is not limited thereto. Furthermore, the cloud network 10 may transmit and receive information using short-range communications or long-distance communications. The short-range communication may include Bluetooth®, radio frequency identification (RFID), infrared data association (IrDA), ultra-wideband (UWB), ZigBee, and wireless-fidelity (Wi-Fi) technologies, and the long-range communication may include code division multiple access (CDMA), frequency division multiple access (FDMA), time division multiple access (TDMA), orthogonal frequency division multiple access (OFDMA), and single carrier frequency division multiple access (SC-FDMA).

The cloud network 10 may include connection of network elements such as hubs, bridges, routers, switches, and gateways. The cloud network 10 may include one or more connected networks, including a public network such as the Internet and a private network such as a secure corporate private network. For example, the network may include a multi-network environment. The access to the cloud network 10 can be provided via one or more wired or wireless access networks. Furthermore, the cloud network 10 may support 5G communication and/or an Internet of things (IoT) network for exchanging and processing information between distributed components such as objects.

The AI server 20 may include a server performing AI processing and a server performing computations on big data. In addition, the AI server 20 may be a database server that provides big data necessary for applying various artificial intelligence algorithms and data for operating the vehicle UX control system 1. In addition, the AI server 20 may include a web server or an application server enabling remote control of the operation of the vehicle UX control system 1 using a vehicle UX control system application or a vehicle UX control system web browser installed in the user terminal 30d.

Further, the AI server 20 is connected to at least one of the AI devices constituting the vehicle UX control system environment, such as the robot 30a, the self-driving vehicle 30b, the XR device 30c, and the user terminal 30d or the home appliance 30e, through the cloud network 10, and can assist at least a part of the AI processing of the AI devices 30a to 30e connected thereto. Here, the AI server 20 may train the AI network according to a machine learning algorithm instead of the AI devices 30a to 30e, and may directly store a learning model or transmit the learning model to the AI devices 30a to 30e. Here, the AI server 20 may receive input data from the AI device 30a to 30e, infer a result value from the received input data by using the learning model, generate a response or control command based on the inferred result value, and transmit the generated response or control command to the AI device 30a to 30e. Similarly, the AI apparatus 30a to 30e may infer a result value from the input data by employing the learning model directly and generate a response or control command based on the inferred result value.

Artificial intelligence (AI) is an area of computer engineering science and information technology that studies methods to make computers mimic intelligent human behaviors such as reasoning, learning, and self-improving.

In addition, artificial intelligence does not exist on its own, but is rather directly or indirectly related to a number of other fields in computer science. In recent years, there have been numerous attempts to introduce an element of AI into various fields of information technology to solve issues in the respective fields.

Machine learning is an area of artificial intelligence that includes the field of study that gives computers the capability to learn without being explicitly programmed. Specifically, machine learning is a technology that investigates and constructs systems, and algorithms for such systems, which are capable of learning, making predictions, and enhancing their own performance on the basis of experiential data. Machine learning algorithms, rather than only executing rigidly set static program commands, may take an approach that builds models for deriving predictions and decisions from inputted data.

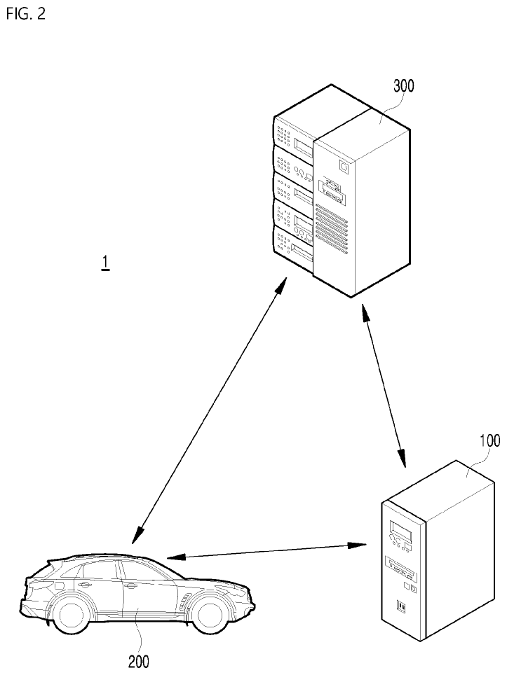

FIG. 2 is a diagram schematically illustrating a communication environment of a vehicle UX control system according to an embodiment of the present disclosure. Description overlapping with that of FIG. 1 will be omitted.

Referring to FIG. 2, the vehicle UX control system 1 may include a vehicle UX control apparatus 100, a vehicle 200, and a server 300. Although the vehicle UX control apparatus 100 is illustrated as being provided outside the vehicle 200, the vehicle UX control apparatus 100 may be disposed in the vehicle 200.

In addition, the vehicle UX control system 1 may further include components such as a user terminal and a network.

In the present embodiment, the server 300 may include a mobile edge computing (MEC) server, an AI server 20, and a server for a processor of the vehicle UX control system 1, and the term may collectively refer to these servers. When the server 300 is another server that is not mentioned in the present embodiment, the connection illustrated in FIG. 2, for example, may be changed.

The AI server may receive data collected from the vehicle 200, and may perform learning to enable optimal UX control.

The MEC server may act as a general server, and may be connected to a base station (BS) next to a road in a radio access network (RAN) to provide flexible vehicle-related services and efficiently operate the network. In particular, network-slicing and traffic scheduling policies supported by the MEC server can assist the optimization of the network. The MEC server is integrated inside the RAN, and may be located in an S1-user plane interface (for example, between the core network and the base station) in a 3GPP system. However, the MEC server is not limited thereto, and may be located in the base station. The MEC server may be regarded as an independent network element, and does not affect the connection of the existing wireless networks. The independent MEC servers may be connected to the base station via the dedicated communication network and may provide specific services to various end-users located in the cell. These MEC servers and the cloud servers may be connected to each other through an Internet-backbone, and share information with each other. Further, the MEC server can operate independently and control a plurality of base stations. Services for self-driving vehicles, application operations such as virtual machines (VMs), and operations at the edge side of mobile networks based on a virtualization platform may be performed. The base station (BS) may be connected to both the MEC servers and the core network to enable flexible user traffic scheduling required for performing the provided services. When a large amount of user traffic occurs in a specific cell, the MEC server may perform task offloading and collaborative processing based on the interface between neighboring base stations. That is, since the MEC server has an open operating environment based on software, new services of an application provider may be easily provided. Since the MEC server performs the service at a location near the end-user, the data round-trip time is shortened and the service providing speed is high, thereby reducing the service waiting time. MEC applications and virtual network functions (VNFs) may provide flexibility and geographic distribution in service environments. When using this virtualization technology, various applications and network functions can be programmed, and only specific user groups may be selected or compiled for them. Therefore, the provided services may be applied more closely to user requirements. In addition to centralized control ability, the MEC server may minimize interaction between base stations. This may simplify the process for performing basic functions of the network, such as handover between cells. This function may be particularly useful in autonomous driving systems used by a large number of users. In the autonomous driving system, the terminals of the road may periodically generate a large amount of small packets. In the RAN, the MEC server may reduce the amount of traffic that must be delivered to the core network by performing certain services. This may reduce the processing burden of the cloud in a centralized cloud system, and may minimize network congestion. The MEC server may integrate network control functions and individual services, which can increase the profitability of mobile network operators (MNOs). Installation density adjustment enables fast and efficient maintenance and upgrades. In addition, in the present embodiment, the server 300 may be a service application server for providing service applications that are executable in the vehicle 200.

The vehicle 200 may include a vehicle communication module, a vehicle control module, a vehicle user interface module, a driving manipulation module, a vehicle driving module, an operation module, a navigation module, a sensing module, and the like. The vehicle 200 may include other components than the components described, or may not include some of the components described, depending on the embodiment.

Here, the vehicle 200 may be a self-driving vehicle, and may be switched from an autonomous driving mode to a manual mode, or switched from the manual mode to the autonomous driving mode according to a user input received through the vehicle user interface module. In addition, the vehicle 200 may be switched from an autonomous mode to a manual mode, or switched from the manual mode to the autonomous mode depending on the driving situation. Here, the driving status can be determined by at least one of information received by the vehicle communication module, external object information detected by the sensing module, and navigation information obtained by the navigation module.

When the vehicle 200 is operated in the autonomous mode, the vehicle 200 may be operated according to the control of the operation module that controls driving, parking, and unparking operations. Meanwhile, when the vehicle 200 is driven in the manual mode, the vehicle 200 may be driven by a user input through the driving manipulation module. The vehicle 200 may be connected to an external server through a communication network, and may be capable of moving along a predetermined route without a driver's intervention by using an autonomous driving technique.

The vehicle user interface module may receive an input signal of the user, transmit the received input signal to the vehicle user interface module, and provide information held by the vehicle 200 to the user by the control of the vehicle control module.

The operation module may control various operations of the vehicle 200, and in particular, may control various operations of the vehicle 200 in an autonomous driving mode. The operation module may include, but is not limited to, a driving module, a starting module, and a parking module. In addition, the operation module may include a processor that is controlled by the vehicle control module. Each module of the operation module may include its own individual processor. Depending on the embodiment, when the operation module is implemented as software, the operation module may be a sub-concept of the vehicle control module. The driving module, the unparking module, and the parking module may respectively drive, unpark, and park the vehicle 200. In addition, the driving module, the unparking module, and the parking module may each receive object information from the sensing module, and provide a control signal to the vehicle driving module, and thereby drive, unpark, and park the vehicle 200. In addition, the driving module, the unparking module, and the parking module may each receive a signal from an external device through the vehicle communication module, and provide a control signal to the vehicle driving module, and thereby drive, unpark, and park the vehicle 200. In addition, the driving module, the unparking module, and the parking module may each receive navigation information from the navigation module, and provide a control signal to the vehicle driving module, and thereby drive, unpark, and park the vehicle 200. The navigation module can provide the navigation information to the vehicle control module. The navigation information may include at least one of map information, set destination information, route information according to destination setting, information about various objects on the route, lane information, or current location information of the vehicle.

The sensing module can sense the state of the vehicle 200, that is, detect a signal about the state of the vehicle 200, by using a sensor mounted on the vehicle 200, and acquire route information of the vehicle according to the sensed signal. The sensing module can provide the obtained moving path information to the vehicle control module. In addition, the sensing module may sense an object around the vehicle 200 using a sensor mounted in the vehicle 200.

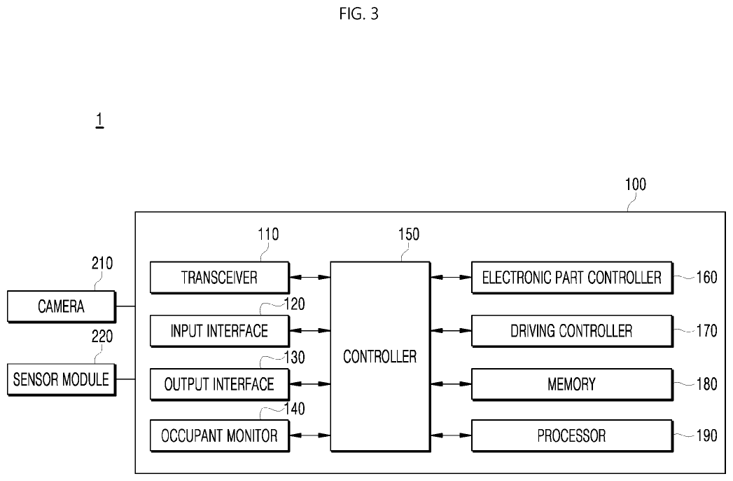

FIG. 3 is a schematic block diagram of the vehicle UX control system according to an embodiment of the present disclosure. Hereinbelow, description overlapping with that of FIGS. 1 and 2 will be omitted.

Referring to FIG. 3, the vehicle UX control system 1 may include a camera 210 and a sensor module 220, which are provided inside the vehicle, and may further include a vehicle UX control apparatus 100.

The camera 210 may include an image sensor provided inside the vehicle. In this case, the position of the camera 210 is not limited, but the camera 210 may be provided in the front side of the vehicle or in the front surface of each seat. A plurality of the cameras 210 may be provided, however, the number of the cameras 210 is not limited. In the present embodiment, the camera 210 may photograph the occupant and may recognize the occupant based on the image of the occupant.

The sensor module 220 may include various sensors provided inside the vehicle. For example, in the present embodiment, the sensor module 220 may include such sensors as a body temperature sensor for detecting a temperature of the occupant, a voice sensor for detecting a voice of the occupant, and a display touch sensor for detecting a touch range and touch intensity of an occupant on a display. However, the type of sensor is not limited thereto, and a single sensor and a composite sensor may be included. The camera 210 and the sensor module 220 of the vehicle UX control system 1 may be included in the sensing module, which is the above-described component of the vehicle 200, or in an input interface 120 to be described later.

The vehicle UX control apparatus 100 may include a transceiver 110, an input interface 120, an output interface 130, an occupant monitor 140, a controller 150, an electronic part controller 160, a driving controller 170, a memory 180, and a processor 190.

The transceiver 110 may be a communication module for enabling communication between the vehicle and the server (300 in FIG. 2) or other external devices. That is, the transceiver 110 may be included in the vehicle communication module, which is the above-described component of the vehicle 200.

The transceiver 110 may support communication by a plurality of communication modes, may receive a server signal from the server 300, and may transmit a signal to the server 300. In addition, the transceiver 110 may receive a signal from one or more other vehicles, may transmit a signal to the other vehicles, may receive a signal from a user terminal, and may transmit a signal to the user terminal. Further, the communicator 110 may include communication modules for communication inside the vehicle.

Here, the communication modes may include, for example, an inter-vehicle communication mode for communication with another vehicle, a server communication mode for communication with an external server, a short-distance communication mode for communication with a user terminal such as a user terminal inside the vehicle, and an intra-vehicle communication mode for communication with units inside the vehicle. In other words, the transceiver 110 may include, for example, a wireless communication module, a V2X communication module, or a short-distance communication module.

The wireless communication module can transmit and receive signals to and from the user terminal or the server through a mobile communication network. Here, the mobile communication network is a multiple access system capable of supporting communication with multiple users by sharing used system resources (for example, bandwidth or transmission power). Examples of the multiple access system include a code division multiple access (CDMA) system, a frequency division multiple access (FDMA) system, a time division multiple access (TDMA) system, an orthogonal frequency division multiple access (OFDMA) system, a single carrier frequency division multiple access (SC-FDMA) system, and a multi-carrier frequency division multiple access (MC-FDMA) system.

The V2X communication module can transmit and receive signals to and from an RSU using a V2I communication protocol in a wireless manner, transmit and receive signals to and from another vehicle using a V2V communication protocol, and transmit and receive signals to and from a user terminal, in other words, a pedestrian or a user, using a V2P communication protocol. In other words, the V2X communication module may include an RF circuit capable of implementing the V2I communication protocol (communication with infrastructure), the V2V communication protocol (communication between vehicles), and the V2P communication protocol (communication with a user terminal). That is, the vehicle interface 110 may include at least one among a transmit antenna and a receive antenna for performing communication, and a radio frequency (RF) circuit and an RF element capable of implementing various communication protocols.

The short-range transceiver may be connected to the user terminal of the driver through a short-range wireless communication module. In this case, the short-range transceiver may be connected to the user terminal through wired communication as well as wireless communication. For example, if the user terminal of the driver is registered in advance, the short-range communication module allows the user terminal to be automatically connected to the vehicle 200 when the registered user terminal is recognized within a predetermined distance from the vehicle 200 (for example, when inside the vehicle). That is, the vehicle transceiver 110 may perform short-range communication, GPS signal reception, V2X communication, optical communication, broadcast transmission and reception, and intelligent transport systems (ITS) communication. The transceiver 110 may support short-range communication by using at least one among Bluetooth™, radio frequency identification (RFID), infrared data association (IrDA), ultra-wideband (UWB), ZigBee, near-field communication (NFC), wireless-fidelity (Wi-Fi), Wi-Fi Direct, and wireless universal serial bus (Wireless USB) technologies. The vehicle transceiver 110 may further support other functions than the functions described, or may not support some of the functions described, depending on the embodiment.

Further, depending on the embodiment, the overall operations of the respective modules of the communicator 110 can be controlled by an individual processor provided in the communicator 110. The vehicle transceiver 110 may include a plurality of processors, or may not include a processor. When the transceiver 110 does not include a processor, the transceiver 110 may be operated under the control of the processor of another device in the vehicle 200 or the controller 200.

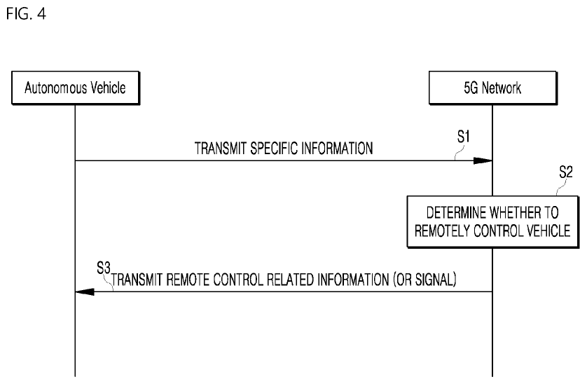

FIG. 4 is a diagram illustrating an example of the basic operation of an autonomous vehicle and a 5G network in a 5G communication system.

The transceiver 110 may transmit specific information over a 5G network when the vehicle 200 is operated in the autonomous driving mode.

At this time, the specific information may include autonomous driving related information.

The autonomous driving related information may be information directly related to the driving control of the vehicle. For example, the autonomous driving related information may include at least one among object data indicating an object near the vehicle, map data, vehicle status data, vehicle location data, and driving plan data.

The autonomous driving related information may further include service information necessary for autonomous driving. For example, the specific information may include information regarding a destination inputted through the vehicle user interface module and the safety level of the vehicle.

In addition, the 5G network may determine whether to remotely control the vehicle 200 (S2).

The 5G network may include a server or a module for performing remote control related to autonomous driving.

The 5G network may transmit information (or a signal) related to the remote control to an autonomous vehicle (S3).

As described above, information related to the remote control may be a signal directly applied to the autonomous vehicle, and may further include service information necessary for autonomous driving. The autonomous vehicle according to the present embodiment may receive service information such as insurance for each interval selected on a driving route and risk interval information, through a server connected to the 5G network to provide services related to the autonomous driving.

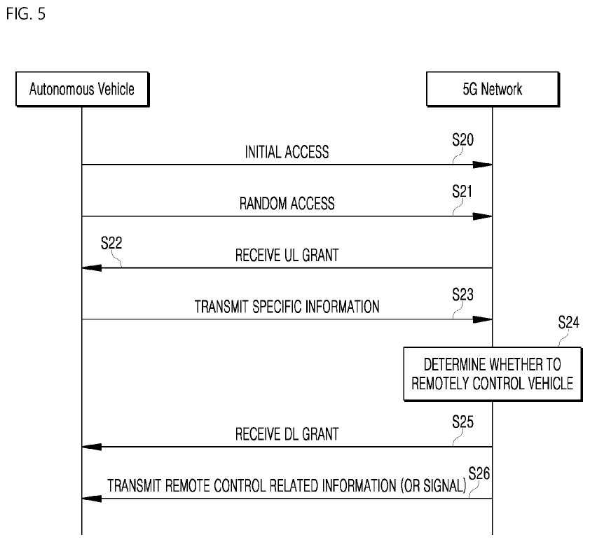

An essential process for performing 5G communication between the autonomous vehicle 200 and the 5G network (for example, an initial access process between the vehicle and the 5G network) will be briefly described with reference to FIG. 5 to FIG. 9 below.

An example of application operations through the autonomous vehicle 200 performed in the 5G communication system and the 5G network is as follows.

The vehicle 200 may perform an initial access process with the 5G network (initial access step, S20). In this case, the initial access procedure includes a cell search process for acquiring downlink (DL) synchronization and a process for acquiring system information.

The vehicle 200 may perform a random access process with the 5G network (random access step, S21). At this time, the random access procedure includes an uplink (UL) synchronization acquisition process or a preamble transmission process for UL data transmission, a random access response reception process, and the like.

The 5G network may transmit an uplink (UL) grant for scheduling transmission of specific information to the autonomous vehicle 200 (UL grant receiving step, S22).

The procedure by which the vehicle 200 receives the UL grant includes a scheduling process in which a time/frequency resource is allocated for transmission of UL data to the 5G network.

Further, the autonomous vehicle 200 can transmit specific information to the 5G network based on the UL grant (specific information transmission step, S23).

The 5G network may determine whether the vehicle 200 is to be remotely controlled based on the specific information transmitted from the vehicle 200 (vehicle remote control determination step, S24).

The autonomous vehicle 200 may receive the DL grant through a physical DL control channel for receiving a response on pre-transmitted specific information from the 5G network (DL grant receiving step, S25).

The 5G network may transmit information (or signal) related to the remote control to the autonomous vehicle 200 based on the DL grant (remote control related information transmission step, S26).

A process in which the initial access process and/or the random access process between the 5G network and the autonomous vehicle 200 is combined with the DL grant receiving process has been exemplified. However, the present disclosure is not limited thereto.

For example, an initial access procedure and/or a random access procedure may be performed through an initial access step, an UL grant reception step, a specific information transmission step, a remote control decision step of the vehicle, and an information transmission step associated with remote control. In addition, for example, the initial access process and/or the random access process may be performed through the random access step, the UL grant receiving step, the specific information transmission step, the vehicle remote control determination step, and the remote control related information transmission step. The autonomous vehicle 200 may be controlled by the combination of an AI operation and the DL grant receiving process through the specific information transmission step, the vehicle remote control determination step, the DL grant receiving step, and the remote control related information transmission step.

The operation of the autonomous vehicle 200 described above is merely exemplary, and the present disclosure is not limited thereto.

For example, the operation of the autonomous vehicle 200 may be performed by selectively combining the initial access step, the random access step, the UL grant receiving step, or the DL grant receiving step with the specific information transmission step, or the remote control related information transmission step. The operation of the autonomous vehicle 200 may include the random access step, the UL grant receiving step, the specific information transmission step, and the remote control related information transmission step. The operation of the autonomous vehicle 200 may include the initial access step, the random access step, the specific information transmission step, and the remote control related information transmission step. The operation of the autonomous vehicle 200 may include the UL grant receiving step, the specific information transmission step, the DL grant receiving step, and the remote control related information transmission step.

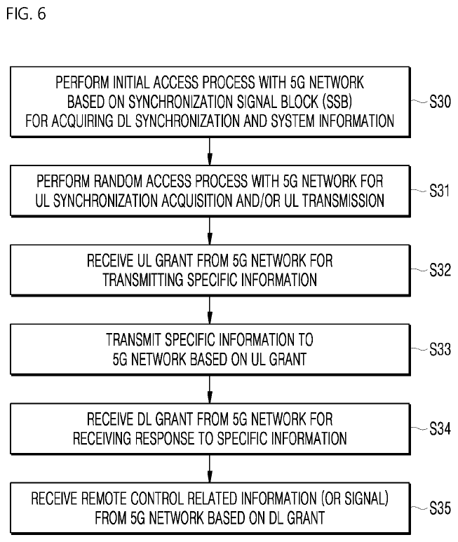

As illustrated in FIG. 6, the vehicle 200 including an autonomous driving module may perform an initial access process with the 5G network based on Synchronization Signal Block (SSB) for acquiring DL synchronization and system information (initial access step, S30).

The autonomous vehicle 200 may perform a random access process with the 5G network for UL synchronization acquisition and/or UL transmission (random access step, S31).

The autonomous vehicle 200 may receive the UL grant from the 5G network for transmitting specific information (UL grant receiving step, S32).

The autonomous vehicle 200 may transmit the specific information to the 5G network based on the UL grant (specific information transmission step, S33).

The autonomous vehicle 200 may receive the DL grant from the 5G network for receiving a response to the specific information (DL grant receiving step, S34).

The autonomous vehicle 200 may receive remote control related information (or signal) from the 5G network based on the DL grant (remote control related information receiving step, S35).

A beam management (BM) process may be added to the initial access step, and a beam failure recovery process associated with Physical Random Access Channel (PRACH) transmission may be added to the random access step. Quasi co-location (QCL) relation may be added with respect to the beam reception direction of a Physical Downlink Control Channel (PDCCH) including the UL grant in the UL grant receiving step, and QCL relation may be added with respect to the beam transmission direction of the Physical Uplink Control Channel (PUCCH)/Physical Uplink Shared Channel (PUSCH) including specific information in the specific information transmission step. Further, a QCL relationship may be added to the DL grant reception step with respect to the beam receiving direction of the PDCCH including the DL grant.

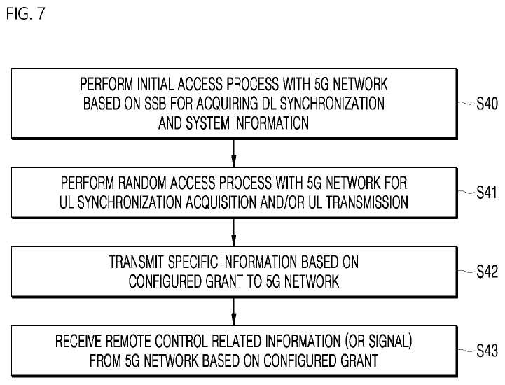

As illustrated in FIG. 7, the autonomous vehicle 200 may perform an initial access process with the 5G network based on SSB for acquiring DL synchronization and system information (initial access step, S40).

The autonomous vehicle 200 may perform a random access process with the 5G network for UL synchronization acquisition and/or UL transmission (random access step, S41).

The autonomous vehicle 200 may transmit specific information based on a configured grant to the 5G network (UL grant receiving step, S42). In other words, the autonomous vehicle 1000 may receive the configured grant instead of receiving the UL grant from the 5G network.

The autonomous vehicle 200 may receive the remote control related information (or signal) from the 5G network based on the configured grant (remote control related information receiving step, S43).

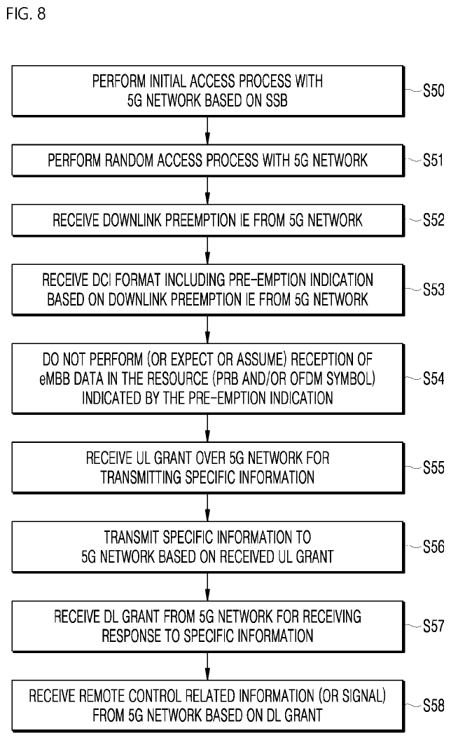

As illustrated in FIG. 8, the autonomous vehicle 200 may perform an initial access process with the 5G network based on SSB for acquiring DL synchronization and system information (initial access step, S50).

The autonomous vehicle 200 may perform a random access process with the 5G network for UL synchronization acquisition and/or UL transmission (random access step, S51).

In addition, the autonomous vehicle 200 may receive Downlink Preemption (DL) and Information Element (IE) from the 5G network (DL Preemption IE reception step, S52).

The autonomous vehicle 200 may receive DCI (Downlink Control Information) format 2_1 including preemption indication based on the DL preemption IE from the 5G network (DCI format 2_1 receiving step, S53).

The autonomous vehicle 200 may not perform (or expect or assume) the reception of eMBB data in the resource (PRB and/or OFDM symbol) indicated by the pre-emption indication (step of not receiving eMBB data, S54).

The autonomous vehicle 200 may receive the UL grant over the 5G network for transmitting specific information (UL grant receiving step, S55).

The autonomous vehicle 200 may transmit the specific information to the 5G network based on the UL grant (specific information transmission step, S56).

The autonomous vehicle 200 may receive the DL grant from the 5G network for receiving a response to the specific information (DL grant receiving step, S57).

The autonomous vehicle 200 may receive the remote control related information (or signal) from the 5G network based on the DL grant (remote control related information receiving step, S58).

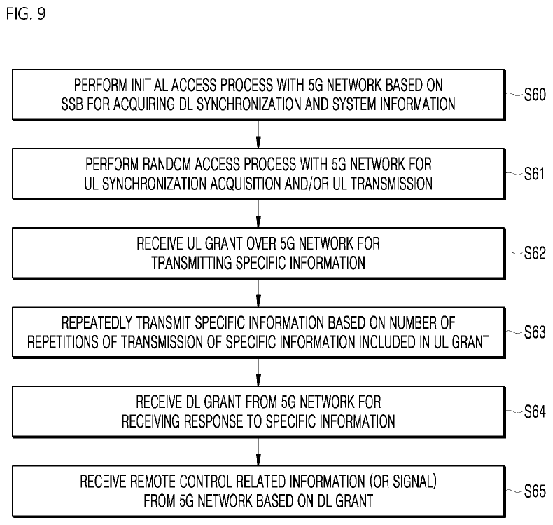

As illustrated in FIG. 9, the autonomous vehicle 200 may perform an initial access process with the 5G network based on SSB for acquiring DL synchronization and system information (initial access step, S60).

The autonomous vehicle 200 may perform a random access process with the 5G network for UL synchronization acquisition and/or UL transmission (random access step, S61).

The autonomous vehicle 200 may receive the UL grant over the 5G network for transmitting specific information (UL grant receiving step, S62).

When specific information is transmitted repeatedly, the UL grant may include information on the number of repetitions, and the specific information may be repeatedly transmitted based on information on the number of repetitions (specific information repetition transmission step, S63).

The autonomous vehicle 200 may transmit the specific information to the 5G network based on the UL grant.

Also, the repetitive transmission of specific information may be performed through frequency hopping, the first specific information may be transmitted in the first frequency resource, and the second specific information may be transmitted in the second frequency resource.

The specific information may be transmitted through Narrowband of 6 Resource Block (6RB) and 1 Resource Block (1RB).

The autonomous vehicle 200 may receive the DL grant from the 5G network for receiving a response to the specific information (DL grant receiving step, S64).

The autonomous vehicle 200 may receive the remote control related information (or signal) from the 5G network based on the DL grant (remote control related information receiving step, S65).

The above-described 5G communication technique can be applied in combination with the embodiment proposed in this specification, which will be described in FIG. 1 to FIG. 13, or supplemented to specify or clarify the technical feature of the embodiment proposed in this specification.

The input interface 120 and the output interface 130 may perform a user interface function, and thus may be included in the vehicle user interface module, which is the above-described component of the vehicle 200.

The input interface 120 may receive information from a user, e.g. the passengers as well as the driver of the vehicle 200. That is, the input interface 120 may be provided for communication between the vehicle 200 and the vehicle user, and may receive a signal input by the user through various manners such as display touch and voice. In the present embodiment, the data collected from the user through the input interface 120 may be analyzed by the controller 150 and may be processed to determine a user's control command. For example, the input interface 120 may receive a destination of the vehicle 200 from the user, and may provide the destination to the controller 150. In addition, the input interface 120 may receive a request for performing the autonomous driving of the vehicle 200 from the user, and may provide the same to the controller 150. In addition, the input interface 120 may receive a request for an entertainment function from the user, and may provide the same to the controller 150.

The input interface 120 may be disposed inside the vehicle. For example, the input interface 120 may be disposed in one area of a steering wheel, one area of an instrument panel, one area of a seat, one area of each pillar, one area of a door, one area of a center console, one area of a head lining, one area of a sun visor, one area of a windshield, or one area of a window.

The output interface 130 may be provided to generate a sensory output related to, for example, a sense of sight, a sense of hearing, or a sense of touch. The output interface 130 may output a sound or an image. Furthermore, the output interface 130 may include at least one of a display module, a sound output module, and a haptic output module.

The display module may display graphic objects corresponding to various information. The display module may include at least one of a liquid crystal display (LCD), a thin film transistor liquid crystal display (TFT LCD), an organic light emitting diode (OLED), a flexible display, a 3D display, or an e-ink display. The display module may form an interactive layer structure with a touch input module, or may be integrally formed with the touch input module to implement a touch screen. The display module may be implemented as a head-up display (HUD). When the display module is implemented as an HUD, the display module may include a projection module to output information through an image projected onto a windshield or a window. The display module may include a transparent display. The transparent display may be attached to the windshield or the window. The transparent display may display a predetermined screen with a predetermined transparency. The transparent display may include at least one of a transparent thin film electroluminescent (TFEL), a transparent organic light-emitting diode (OLED), a transparent liquid crystal display (LCD), a transmissive transparent display, or a transparent light emitting diode (LED). The transparency of the transparent display may be adjusted. The output interface 130 may include a plurality of display modules. The display module may be disposed on one area of a steering wheel, one area of an instrument panel, one area of a seat, one area of each pillar, one area of a door, one area of a center console, one area of a head lining, or one area of a sun visor, or may be implemented on one area of a windshield or one area of a window.

The sound output module may convert an electric signal provided from the controller 150 into an audio signal, and output the audio signal. The sound output module may include at least one speaker.

The haptic output module may generate a tactile output. For example, the haptic output module may operate to allow the user to perceive the output by vibrating a steering wheel, a seat belt, and a seat.

The occupant monitor 140 may be provided to monitor the occupants of the vehicle 200. For example, the occupant monitor 140 may include sensors such as an image sensor, a voice sensor and a body sensor, to recognize each occupant and monitor information about each occupant. In the present embodiment, the occupant monitor 140 may receive data about the occupants through the camera 210 and the sensor module 220, and may monitor each occupant. In this case, the occupant monitor 140 may be provided with a separate processor. However, when not provided with a separate processor, the occupant monitor 140 may be controlled by the controller 150.

The controller 150 may control the overall operation of the vehicle UX control apparatus 100. The controller 150 may recognize the occupant through the transceiver 110 and/or the occupant monitor 140, may determine the type of recognized occupant, and may provide a user interface corresponding to the type of occupant, i.e. the input interface 120 and the output interface 130. In addition, the controller 150 may perform a process corresponding to the user request inputted by the occupant through the input interface 120. For example, the controller 150 may provide the output interface 130 corresponding to the user request from the occupant. In addition, the controller 150 may control the electronic part controller 160 and the driving controller 170 in response to the user request from the occupant based on the type of occupant.

The controller 150 may be a sort of central processor, and specifically, may refer to a processor capable of controlling the overall operation of the vehicle 200 by executing the control software installed in the memory 180. The processor may include any kind of device capable of processing data. Here, the term “processor” may refer to a data processing device built in hardware, which includes physically structured circuits in order to perform functions represented as a code or command present in a program. Examples of the data processing device built in hardware may include microprocessors, central processors (CPUs), processor cores, multiprocessors, application-specific integrated circuits (ASICs), digital signal processors (DSPs), digital signal processing devices (DSPDs), programmable logic devices (PLDs), processors, controllers, micro-controllers, and field programmable gate array (FPGA), but the present disclosure is not limited thereto.

In the present embodiment, the controller 150 may perform machine learning such as deep learning so that the vehicle UX control system 1 performs optimal UX control, and the memory 180 may store data used for machine learning, result data, and so on.

Deep learning, which is a subfield of machine learning, enables data-based learning through multiple layers. As the number of layers in deep learning increases, the deep learning network may acquire a collection of machine learning algorithms that extract core data from multiple datasets.

Deep learning structures may include an artificial neural network (ANN). For example, the deep learning structure may include a deep neural network (DNN), such as a convolutional neural network (CNN), a recurrent neural network (RNN), and a deep belief network (DBN). The deep learning structure according to the present embodiment may use various structures well known in the art. For example, the deep learning structure according to the present disclosure may include a CNN, a RNN, and a DBN. RNN is widely used in natural language processing and may configure an artificial neural network structure by building up layers at each instant in a structure that is effective for processing time-series data which vary with time. A DBN may include a deep learning structure formed by stacking up multiple layers of restricted Boltzmann machines (RBM), which is a deep learning scheme. When a predetermined number of layers are constructed by repetition of RBM learning, the DBN having the predetermined number of layers may be constructed. CNN includes a model mimicking a human brain function, built on the assumption that when a person recognizes an object, the brain extracts basic features of the object and recognizes the object based on the results of complex processing in the brain.

Further, the artificial neural network may be trained by adjusting weights of connections between nodes (if necessary, adjusting bias values as well) so as to produce a desired output from a given input. Furthermore, the artificial neural network may continuously update the weight values through training. Furthermore, a method of back propagation, for example, may be used in the learning of the artificial neural network.

That is, an artificial neural network may be installed in the vehicle UX control system 1, and the controller 150 may include an artificial neural network, for example, a deep neural network (DNN) such as a CNN, an RNN, and a DBN. Therefore, the controller 150 may perform learning using the deep neural network for optimal UX control of the vehicle UX control system 1. As a machine learning method for such an artificial neural network, both unsupervised learning and supervised learning may be used. The controller 150 may control so as to update an artificial neural network structure after learning according to a setting.

The electronic part controller 160 may be provided to control the electronic parts of the vehicle 200. The electronic part controller 160 may control the electronic parts of the vehicle in response to a control signal from the controller 150. For example, the electronic part controller 160 may, for example, operate doors and windows of the vehicle 200.

The driving controller 170 may control various operations of the vehicle 200, and in particular, may control various operations of the vehicle 200 in the autonomous driving mode. That is, when the autonomous driving mode is performed in response to a control signal from the controller 150, the driving controller 170 may control the driving of the vehicle 200.

The driving controller 170 may include a driving module, an unparking module, and a parking module, but the present disclosure is not limited thereto. In addition, the driving controller 170 may include a processor that is controlled by the controller 150. Each module of the driving controller 170 may include a processor individually. Depending on the embodiment, when the driving controller 170 is implemented as software, it may be a sub-concept of the vehicle controller 150. The driving module, the unparking module, and the parking module may respectively drive, unpark, and park the vehicle 200. In addition, the driving module, the unparking module, and the parking module may each receive object information from the sensing module, and provide a control signal to the vehicle driving module, and thereby drive, unpark, and park the vehicle 200. In addition, the driving module, the unparking module, and the parking module may each receive a signal from an external device through the transceiver 110, and provide a control signal to the vehicle driving module, and thereby drive, unpark, and park the vehicle 200. In addition, the driving module, the unparking module, and the parking module may each receive navigation information from the navigation module, and provide a control signal to the vehicle driving module, and thereby drive, unpark, and park the vehicle 200. The navigation module may provide the navigation information to the controller 150. The navigation information may include at least one of map information, set destination information, route information according to destination setting, information about various objects on the route, lane information, or current location information of the vehicle.

The memory 180 may be connected to one or more processors, and may store codes that, when executed by the processor, cause the processor to control the vehicle UX control system 1. That is, in the present embodiment, the memory 180 may store codes that, when executed by the controller 150, cause the controller 150 to control the vehicle UX control system 1. The memory 180 may store various codes and various pieces of information necessary for the vehicle UX control system 1, and may include a volatile or nonvolatile recording medium.

Here, the memory 180 may include a magnetic storage media or a flash storage media. However, the present disclosure is not limited thereto. The memory 180 may include a built-in memory and/or an external memory, and may include a storage, for example, a volatile memory such as a DRAM, an SRAM, or an SDRAM, a non-volatile memory such as a one time programmable ROM (OTPROM), a PROM, an EPROM, an EEPROM, a mask ROM, a flash ROM, a NAND flash memory, or a NOR flash memory, a flash drive such as an SSD, a compact flash (CF) card, an SD card, a Micro-SD card, a Mini-SD card, an Xd card, or a memory stick, or a storage device such as an HDD.

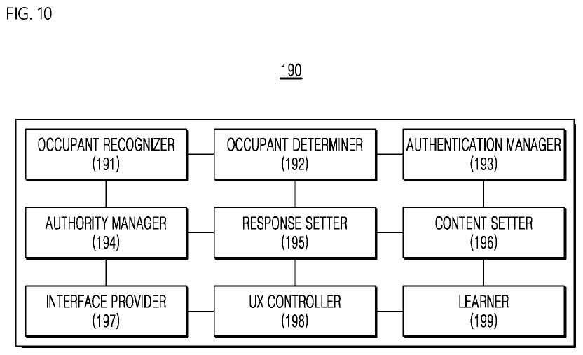

The processor 190 may monitor the interior of the vehicle 200 so as to recognize the occupant, may determine the type of occupant, and may provide a user interface corresponding to the type of occupant. In addition, the processor 190 may perform a process corresponding to the user request input by the occupant through the user interface. In the present embodiment, the processor 190 may be provided outside the controller 150 as illustrated in FIG. 3, may be provided inside the controller 150, or may be provided inside the AI server 20 of FIG. 1. Hereinafter, a detailed operation of the processor 190 will be described with reference to FIG. 10.

FIG. 10 is a schematic block diagram of the processor according to an embodiment of the present disclosure. In the following description, the same description as that in FIGS. 1 to 9 will be omitted.

Referring to FIG. 10, the processor 190 may include an occupant recognizer 191, an occupant determiner 192, an authentication manager 193, an authority manager 194, a response setter 195, a content setter 196, an interface provider 197, a UX controller 198, and a learner 199.

The occupant recognizer 191 may monitor the interior of the vehicle to recognize the occupant. In the present embodiment, the occupant recognizer 191 may recognize the occupant through the image of the occupant captured by the camera 210 installed in the interior of the vehicle 200. For example, the occupant recognizer 191 may recognize, for example, the number of occupants, whether the recognized object is a human occupant or a thing, the age or the gender, using a face recognition algorithm, an object discrimination algorithm, and the like. In this case, the face recognition algorithm or the object discrimination algorithm may be a learning model based on machine learning. In addition, when the occupant changes position, the occupant recognizer 191 may recognize the change in the position of the occupant, and may recognize the changed position. For example, the occupant recognizer 191 may recognize the presence of the occupant, then may map information about the occupant obtained through, for example, a weight sensor and a vision sensor to store the information of occupant, and may compare the recognized occupant with an occupant who has previously been mapped in the corresponding position periodically or when a specific event (e.g. when vehicles starts after parking or stopping, and when the occupant reenters after getting out) occurs. In addition, the occupant recognizer 191 may recognize an occupant in each seat. In some cases, the occupant recognizer 191 may also recognize a plurality of occupants in one seat. This may be, for example, the case in which an adult is accompanied by a child or an animal.

The occupant determiner 192 may determine the category of the occupant recognized by the occupant recognizer 191. That is, the occupant determiner 192 may determine the category to which an unauthenticated occupant belongs, among a plurality of preset categories. For example, the occupant determiner 192 may determine the category of the occupant based on the information about the occupant recognized by the occupant recognizer 191, such as whether the recognized object is a human or a thing, male or female and status regarding age. When several occupants are present, the occupant determiner 192 may determine the category of each occupant. For example, in the present embodiment, the occupant may be classified as, for example, an adult, a child, a disabled person, an animal. A plurality of such categories may be preset.

In the present embodiment, the occupant determiner 192 may determine at least one of whether the recognized object is human, a gender of the object, an age of the object, or a disability status of the object, based on at least one of the image of the occupant captured by the camera 210 mounted in the interior of the vehicle, the temperature of the occupant, the voice of the occupant, or the touch range and touch intensity of the occupant on the display, which is detected by the sensor module 220.

The occupant determiner 192 may primarily determine at least one of whether the occupant is a human, a gender of the occupant, an age of the occupant, or whether the occupant is disabled, based on the image of the occupant captured by the camera 210. In addition, the occupant determiner 192 may convert the determined type of occupant into a probability value, and may additionally determine the type of occupant based on the probability value. For example, when the occupant type probability value is equal to or less than a reference value, the occupant determiner 192 may determine whether the recognized object is human, whether male or female, status regarding age, or status regarding disability, based further on at least one of the temperature of the occupant, the voice of the occupant, or the touch range and touch intensity of the occupant on the display, which is detected by the sensor module 220. Here, the display may be a user interface. The occupant determiner 192 may additionally determine the type of occupant based on the direction in which the arms of the occupant are oriented, which is recognized by the camera 210. For example, when the touch area is greater than or equal to a reference value and when the touch intensity is greater than or equal to a reference value, the occupant determiner 192 may determine that the recognized occupant is an adult. In addition, the occupant determiner 192 may differentiate between a human and an animal based on the difference in the temperature between humans and animals.

In addition, when the occupant type probability value is less than or equal to the reference value, the occupant determiner 192 may determine the type of occupant based on the response or reaction of the occupant to the content provided based on the probability value. For example, in the present embodiment, the occupant determiner 192 may determine the type of occupant by providing content directly questioning the occupant and receiving a response thereto from the occupant. In addition, in the present embodiment, it is possible to additionally determine whether the occupant is, for example, a visually impaired person, a hearing-impaired person, by outputting an animation on the display, or outputting a sound and measuring the response of the occupant thereto.

In addition, the occupant determiner 192 may determine the type of occupant based on the machine-learning-based learning model, which is trained to determine at least one of whether the recognized occupant is human, a gender of the occupant, an age of the occupant, or a disability status of the occupant, by receiving at least one of the image of the occupant, data regarding the temperature of the occupant, data regarding the voice of the occupant, the touch range, the touch intensity, or response of the occupant to preset content.

In other words, the occupant determiner 192 may determine whether each recognized object is a human occupant through the occupant recognizer 191 using an object recognition algorithm. Upon determining that the recognized object is a human occupant, the occupant determiner 192 may estimate the gender and age of the occupant using a face recognition algorithm. In addition, the occupant determiner 192 may determine whether the occupant is, for example, a hearing-impaired person and a visually impaired person, based on the recognition of a hearing aid or a guide dog through the camera 210. In this case, the guide dog may be recognized based on an item indicating a guide dog, such as a necklace-type tag.

In the present embodiment, the occupant recognizer 191 and the occupant determiner 192 are described as being provided separately from each other. However, the occupant recognizer 191 and the occupant determiner 192 may be integrated to recognize the occupant and determine the type of occupant.

The authentication manager 193 may authenticate whether the occupant is a registered user, and may provide authentication information to the UX controller 198. That is, the authentication manager 193 may authenticate whether the occupant is a user who has previously been registered in the vehicle 200 or in the vehicle UX control system 1. The authentication manager 193 may perform authentication through recognition of data such as fingerprint and face. In the present embodiment, since the authentication process is performed to control a vehicle, it may be performed only on an adult. In addition, the number of authenticated occupants may be one or more. When the occupant is not an authenticated occupant, the authentication manager 193 may register the corresponding occupant as an authenticated occupant through the authentication process.

In the present embodiment, the occupant authentication may be performed before determining the type of occupant, and may determine the type of unauthenticated occupant, among a plurality of preset categories. However, the present disclosure is not limited thereto.

The authority manager 194 may manage the access authority of the user for all functions that the user of the vehicle 200 is capable of requesting. For example, the occupant may have different access authorities for the respective functions depending on whether the occupant has been authenticated or depending on the type of occupant, and the authority manager 194 may set different access authorities for the respective functions. For example, the access authorities may be set such that only an authenticated adult is capable of accessing an autonomous driving function, and such that a child (e.g. a child under a predetermined age) or an animal is not capable of accessing a door-opening function.

The response setter 195 may set responses to requests inputted by the occupant through the user interface. That is, the response setter 195 may set responses according to the type of occupant. In other words, the response setter 195 may set responses such that a response to the occupant request for a specific function is outputted differently depending on the type of occupant. For example, when an adult occupant requests a door-opening function, the response setter 195 may immediately perform the requested function. However, when an animal requests the door-opening function (e.g. when an animal touches a door-opening function button on the display), a predetermined visual effect such as bubbles may be displayed on the touched area of the display, and a warning sound may be output without opening the door.

The content setter 196 may set the content that may be provided depending on whether the occupant has been authenticated, and depending on the type of the occupant. In addition, the content setter 196 may also set detailed settings such as the display output size and the sound output level of the content when the content is provided.

The interface provider 197 may provide a user interface corresponding to the occupant based on the type of occupant determined by the occupant determiner 192. In addition, the interface provider 197 may provide a user interface based on the result of performing the occupant authentication. That is, the interface provider 197 may provide a user interface suitable for the occupant based on the type of occupant and authentication information.

The interface provider 197 may provide a first user interface to an occupant who has been authenticated as a registered user as a result of occupant authentication performed by the authentication manager 193. In this case, the first user interface may be an interface that provides access to all functions that the user is capable of requesting.

The interface provider 197 may provide a second user interface to the unauthenticated occupant based on the type of unauthenticated occupant, among a plurality of preset categories. In this case, the second user interface may be an interface in which functions that the occupant is capable of accessing, among all functions that the user is capable of requesting, are set differently depending on the type of occupant. For example, the second user interface may be a limited interface, excluding functions for which the unauthenticated occupant does not have access authority, and may be set differently depending on whether the occupant is, for example, an adult, a child, an animal or a disabled person. However, the second user interface may have the same screen configuration regardless of the type of occupant, or may have different screen configurations depending on the type of occupant.

In addition, when the occupant changes position, the interface provider 197 may apply the user interface corresponding to the previous position of the occupant to the user interface corresponding to the current position of the occupant based on the current position of the occupant. In the present embodiment, when the change in the position of the occupant is recognized, an occupant who has already been authenticated may not need to be authenticated again.

The UX controller 198 may perform a process corresponding to the user request inputted by the occupant through the user interface. That is, when a user request is inputted through the first user interface provided to an occupant who has been authenticated as a registered user, the UX controller 198 may perform a process corresponding to the user request inputted by the authenticated occupant through the first user interface.

On the other hand, when a user request is inputted through the second user interface, which is provided to an unauthenticated occupant based on the type of unauthenticated occupant, the UX controller 198 may perform a process that corresponds to the user request received through the second user interface. In this case, the process may be a process that is set differently for the same function depending on the type of the occupant. For example, the UX controller 198, which is configured to perform the function of opening a window, may perform a limited process such that the window is fully opened in response to a request from an adult, but is partially opened in response to a request from a child. In addition, when performing the heater temperature control function, the UX controller 198 may control the temperature of a heater in response to a request from an adult, but may prevent a child from controlling the temperature of a heater, or may allow a child to control the temperature of a heater within a preset control range, or after obtaining adult approval. In addition, when performing an entertainment channel changing function, the UX controller 198 may change the channel in response to a request from an adult, but may prevent a child from changing the channel, or may allow a child to change the channel within an allowed range, or after obtaining an adult approval.

In this case, the UX controller 198 may determine the access authority, specifically, whether the user request is a user request for the performance of a function that an unauthenticated occupant is capable of accessing, and may determine whether to perform a process based on the determined access authority. In the present embodiment, the access authority for each function and the access authority for a detailed setting of each function may be included. For example, the access authority for the autonomous driving function may be set such that only an authenticated adult is capable of accessing the autonomous driving function. The access authority for the safety function such as opening or closing of the window may be set such that an adult is capable of accessing the detailed setting of the function without limitation, but such that a child is capable of opening the window only to a predetermined position.

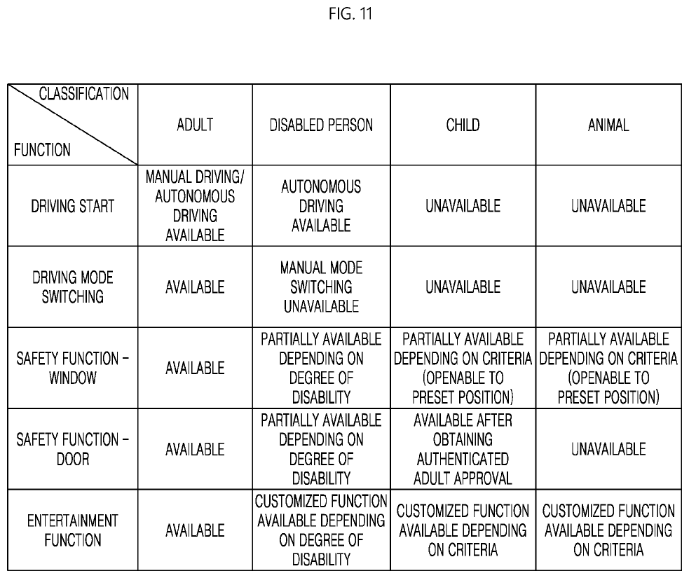

FIG. 11 is an exemplary process table illustrating the performance of functions depending on the type of occupant according to an embodiment of the present disclosure. Examples of performing a process, which is set differently depending on the type of occupant with respect to the same function, will be described with reference to FIG. 11. For example, the UX controller 198 may classify an occupant as an adult, a disabled person, a child, and an animal. The UX controller 198 may provide an autonomous driving start function, a driving mode switching function, a safety function such as opening and closing of the window and the door, and an entertainment function such as playback of multimedia data according to the classified type of occupant in response to a user request input by the occupant. In the present embodiment, the adult and the disabled person in FIG. 11 may be an authenticated adult, and the authenticated adult in the present embodiment may include not only the owner of the vehicle but also a registered adult who is allowed to perform autonomous driving. That is, in the present embodiment, a process may be set such that only an authenticated adult or an authenticated disabled adult who is determined to have the ability to supervise autonomous driving is capable of supervising autonomous driving.

In the present embodiment, the learner 199 may collect parameters for performing trained deep neural network learning. In the present embodiment, data used by an actual user may be collected in order to refine the learning model. In the present embodiment, when the user data is received from the user, input data may be stored in the server and/or the memory regardless of the result of the learning model. That is, in the present embodiment, the vehicle UX control system 1 may store data for optimal UX control in the server to generate big data, and may execute deep learning at the server such that related parameters are updated in the vehicle UX control system 1 and thus become more accurate. However, in the present embodiment, the edge side of the vehicle 200, i.e. the server 300, may execute deep learning and perform update. That is, in the present embodiment, when the vehicle UX control system 1 is initially set, deep learning parameters determined under laboratory conditions may be stored. Thereafter, the deep learning parameters may be updated through data accumulated as the operation for the UX control is repeatedly performed. Therefore, in the present embodiment, the collected data may be labeled to obtain a result through map learning, and the result may be stored in the memory of the vehicle UX control system to complete an evolving algorithm. That is, the vehicle UX control system 1 may collect data for optimal UX control to generate a set of learning data, may learn the set of learning data through a machine learning algorithm, and may determine a learned model. Then, the vehicle UX control system 1 can collect data used by actual users, and retrain at the server with the data to produce a relearned model. Therefore, in the present embodiment, even after being determined as a trained model, data may be continuously collected, and the model may be re-trained by applying a machine learning model, to thereby improve the performance as a re-trained model.

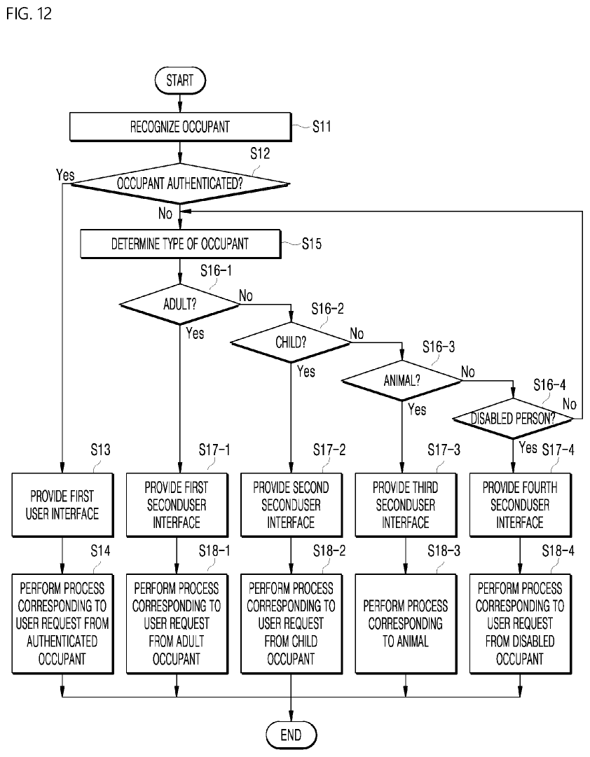

FIG. 12 is a flowchart illustrating a vehicle UX control method according to an embodiment of the present disclosure. In the following description, the same description as that in FIGS. 1 to 11 will be omitted. The process of providing respectively different user interfaces depending on the type of occupant according to the embodiment will be described below with reference to FIG. 12.

In step S11, the controller 150 recognizes an occupant. For example, the controller 150 may recognize an occupant by monitoring the interior of the vehicle through the image of the occupant captured by the camera 210 mounted in the interior of the vehicle 200. In this case, the controller 150 may recognize the number of occupants, and may also recognize the case in which a plurality of occupants sits in one seat (e.g. the case in which an adult sits in one seat while holding a baby or an animal).

In step S12, the controller 150 performs authentication as to whether the occupant is a registered user. For example, the controller 150 may perform authentication through recognition of data such as the fingerprint and face of the occupant. In the present embodiment, since the authentication process is performed to control a vehicle, it may be performed only on an adult. In addition, the number of authenticated occupants may be one or more. Although not illustrated in the drawings, when an unauthenticated occupant is an adult or a disabled adult, the corresponding occupant may be registered later as an authenticated occupant through the authentication process.

In step S13, the controller 150 provides a first user interface to an occupant who has been authenticated as a registered user (YES in step S12). Here, the first user interface may be an interface that provides access to all functions that the user is capable of requesting. For example, the first user interface may be a main interface, which provides access to all of the functions, or provides all of the control screens. Additionally, in the present embodiment, the functions that the user is capable of requesting may include an autonomous driving start function, a driving mode switching function, a safety function such as opening and closing of the window and the door, and an entertainment function such as playback of multimedia data. However, the present disclosure is not limited thereto. In the present embodiment, the driver seat user interface may be activated only when an authenticated adult occupant or an adult rides in the vehicle.

In step S14, the controller 150 performs a process corresponding to a user request inputted by the authenticated occupant through the first user interface. For example, the controller 150 may perform a process corresponding to the user request from the authenticated occupant without a separate approval process.

In step S15, the controller 150 determines the category to which an unauthenticated occupant belongs, among a plurality of preset categories. In this case, the unauthenticated occupant may be classified as, for example, an adult, a child, an animal, and a disabled person. A child may be further classified by age, and a disabled person may be further classified by the degree of disability, or by status as an adult. Additionally, in the present embodiment, a third user interface may be provided before the type of unauthenticated occupant is determined, or before the determination of the type of unauthenticated occupant is completed. The third user interface may be an interface that is provided to a plurality of occupants in the same manner, or may be an interface that is temporarily provided before the determination of the type of occupant is completed. That is, after performing the authentication process, the controller 150 may provide the third user interface to an unauthenticated occupant, and thereafter, may provide respectively different user interfaces depending on the result of determining the type of occupant.

When the unauthenticated occupant is determined to be an adult in step S16-1, the controller 150 provides a first second user interface to the unauthenticated adult occupant in step S17-1. Here, the first second user interface may be an interface that includes a function that an unauthenticated adult occupant is capable of accessing among all of the functions that can be requested by the user. In addition, the controller 150 may provide to the unauthenticated adult occupant an authentication screen for re-authentication. When the occupant is classified as an adult, particularly an aged person or a visually-impaired person, the controller 150 may increase the size of the letters or icons displayed on the first second user interface, thereby enabling the occupant to more easily recognize the same. This may also be applied to an authenticated adult occupant.

In step S18-1, the controller 150 performs a process corresponding to the user request inputted by the unauthenticated adult occupant through the first second user interface. For example, when the unauthenticated adult occupant requests a function that can be provided only to an authenticated adult, the controller 150 may provide a screen or output a warning indicating that the corresponding occupant has no access authority for the requested function. In the present embodiment, the process may be set such that an unauthenticated adult occupant has no access authority for the autonomous driving function, but has the same access authority as an authenticated adult occupant to the remaining functions.

When the unauthenticated occupant is determined to be a child in step S16-2, the controller 150 provides a second second user interface to the child occupant in step S17-2. Here, the second second user interface may be an interface that includes a function that a child occupant is capable of accessing among all of the functions that can be requested by the user. In addition, the controller 150 may arrange the icons displayed on the second second user interface so as to be suitable for the height of the child occupant. In addition, the controller 150 may provide the unauthenticated child occupant with preset content for children through the second second user interface.

In step S18-2, the controller 150 performs a process corresponding to the user request inputted by the unauthenticated child occupant through the second second user interface. For example, when the child occupant inputs a user request, the controller 150 may perform a process only for a function that the child occupant is capable of accessing. In addition, the controller 150 may perform a process for a function that the child occupant is capable of accessing after performing the approval process. In this case, the approval may be realized by an authenticated adult or an unauthenticated adult in the vehicle 200. In some cases, the approval may be realized through a user terminal of an adult who is located outside the vehicle 200. In the present embodiment, an adult who is in the vehicle 200 may perform approval through the user interface of the child occupant or through the user interface of the corresponding adult. When the approval process is completed, the controller 150 may perform a process corresponding to the user request on the user interface of the child occupant. When an approval is not granted, the controller 150 may output a warning.

When the unauthenticated occupant is determined to be an animal in step S16-3, the controller 150 provides a third second user interface to the animal in step S17-3. Here, the third second user interface may be an interface that includes a function that an animal is capable of accessing among all of the functions that can be requested by the user. However, the process may be set such that none of the programs can be accessed by an animal. In addition, upon determining that an animal is in the vehicle, the controller 150 may provide the animal with preset content for animals through the third second user interface.

In step S18-3, the controller 150 performs a process corresponding to the user request through the third second user interface of the animal. For example, upon receiving an input signal from the animal through the third second user interface, the controller 150 may output a predetermined visual effect such as bubbles on the touched area, and may provide a sound effect. In addition, when the animal inputs a user request through the third second user interface, the controller 150 may output a warning to warn other users.

When the unauthenticated occupant is determined to be a disabled person in step S16-4, the controller 150 provides a fourth second user interface to the unauthenticated disabled occupant in step S17-4. Here, the fourth second user interface may be an interface that includes a function that a disabled occupant is capable of accessing, among all of the functions that can be requested by the user. In addition, when the occupant is a visually-impaired person, the controller 150 may increase the size of the letters or icons displayed on the fourth second user interface, or may provide the user interface to a display to which a braille effect is applied. In addition, when the occupant is a hearing-impaired person, the controller 150 may apply a sound effect to the fourth second user interface. In the present embodiment, the determined type of occupant may be converted into a probability value, and content may be provided based thereon. For example, when the probability value approaches 100%, the controller 150 may determine that there is a high possibility that the occupant is a visually-impaired person or a hearing-impaired person. That is, when the probability value approaches 100%, the controller 150 may increase the size of the letters or icons displayed on the fourth second user interface, or may increase the volume of sound output through the fourth second user interface.

In step S18-4, the controller 150 performs a process corresponding to the user request inputted by the unauthenticated disabled occupant through the fourth second user interface. In this case, the controller 150 may differently perform a process corresponding to the user request based on the degree of disability of the unauthenticated disabled occupant. In this case, the degree of disability of the unauthenticated disabled occupant may be automatically recognized through the camera 210 and the sensor module 220 provided in the interior of the vehicle, or may be directly inputted by the occupant through the user interface.

When the determination on the type of occupant based on the preset categories is inaccurate, the controller 150 may return to step S15 to further determine the type of occupant. That is, the controller 150 may convert the determined type of occupant into a probability value, and when the probability value is less than or equal to a reference value, the controller 150 may additionally determine the type of occupant. For example, when the occupant type probability value is less than or equal to the reference value, the controller 150 may determine at least one of whether the occupant is a human, a gender of the occupant, an age of the occupant, or whether the occupant is disabled, based on at least one of the image of the occupant captured by the camera, data regarding the temperature of the occupant, data regarding the voice of the occupant, or the touch range and touch intensity of the occupant on the display which is detected by the sensor module 220. In addition, when the occupant type probability value is less than or equal to the reference value, the controller 150 may determine the type of occupant based on the response or reaction of the occupant to the content provided based on the probability value. For example, in the present embodiment, the controller 150 may determine the type of occupant by providing content directly questioning the occupant and receiving a response thereto from the occupant. In addition, the controller 150 may additionally determine whether the occupant is, for example, a visually-impaired person, a hearing-impaired person, by outputting an animation on the display, or outputting a sound and measuring the occupant's response thereto.

Additionally, in the present embodiment, the controller 150 may recognize a plurality of occupants, and may also recognize two or more occupants in one seat. The controller 150 may also recognize the position of the occupant. Therefore, when the occupant changes position, the controller 150 may apply the user interface corresponding to the previous position of the occupant to a user interface corresponding to the current position of the occupant in the same manner based on the current position of the occupant. In addition, the controller 150 may recognize the change in the position of the occupant, and may continue reproduction of the content, which had been reproduced before the change in the position of the occupant, based on the current position of the occupant. For example, when a child moves from a seat behind the driver seat to a seat behind the front passenger seat, the controller 150 may cause the operation of the display provided at the seat behind the driver seat to stop, such that the display provided at the seat behind the front passenger seat is operated in a child mode, and such that reproduction of the content continues on the display provided at the seat behind the front passenger seat. In addition, when an autonomous vehicle stops at a rest area, and then the occupants reenter the vehicle and sit in different positions, the controller 150 may provide the previous interface to a corresponding occupant in a same manner, and may continue reproduction of the previous content. In this case, when an authenticated adult moves to another seat or reenters the vehicle, the controller 150 may not additionally perform a separate authentication process.

In addition, when two or more occupants who are of different occupant types are recognized as being present in one seat, the controller 150 may enable the occupants to select one of a general mode or a child mode, or change between these two modes. In this case, the controller 150 may output a pop-up window to the user interface to enable selection or changing of the modes. Here, the general mode may be a mode in which the first user interface or the first second user interface is provided, and the child mode may be a mode in which the second second user interface is provided.

In the present embodiment, the controller 150 may provide a limited temporary interface to a shared screen, such as a center information display (CID), which a driver and a passenger sitting in the front passenger seat are both capable of operating. The controller 150 may provide a limited temporary interface for every user request. Upon determining the type of occupant, the controller 150 may provide a user interface corresponding to the type of occupant, and may perform a process corresponding thereto.

In addition, based on whether two or more occupants share a display, the controller 150 may provide a third user interface to an occupant who inputs a user request. In this case, the third user interface may be an interface that is provided in the same manner to all occupants regardless of authentication, access authority, or type. The third user interface may be an interface that includes an authentication-performing function. In addition, based on whether the unauthenticated occupant has requested authentication or whether the determination on the type of occupant has been completed, the controller 150 may provide the third user interface to the corresponding occupant. For example, in the case in which an occupant sitting in the driver seat and an occupant sitting in the front passenger seat share a display provided at the driver's seat or in which two or more occupants sit in one seat and share one display, whenever at least one of the occupants inputs a user request, the controller 150 may provide a user interface for performing authentication, may determine the type of occupant who inputted the user request, may provide a user interface corresponding to the type, and may perform a process corresponding thereto. In addition, when an unauthenticated occupant requests authentication or when an adult occupant needs to be authenticated again, the controller 150 may provide a user interface for performing authentication. In addition, when two or more occupants share one display or when the determination of the type of occupant has not been completed (e.g. when the type determination probability value is less than or equal to a reference value), the controller 150 may temporarily provide the third user interface.

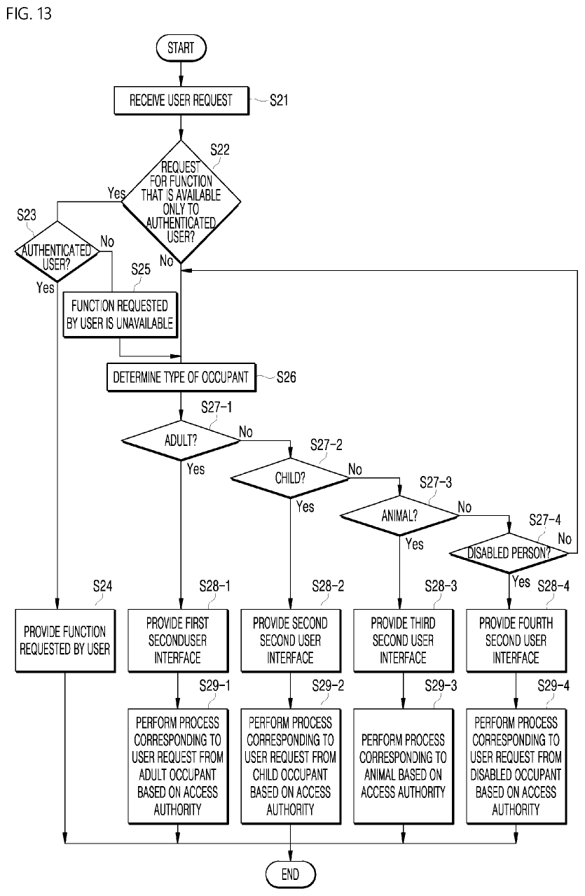

FIG. 13 is a flowchart illustrating a vehicle UX control method based on access authority according to an embodiment of the present disclosure. In the following description, the same description as that in FIGS. 1 to 12 will be omitted. Provision of respectively different interfaces and performance of processes in response to a request for a specific function from an occupant, particularly an unauthenticated occupant, will be described below with reference to FIG. 13.

In step S21, the controller 150 receives a user request. In the present embodiment, after an occupant rides in a vehicle, the controller 150 may perform an occupant recognition step, an occupant authentication step, and an occupant type determination step, and may provide respectively different user interfaces based on whether the occupant has been authenticated, and based on the type of occupant. However, the order in which the above steps are performed is not limited thereto. When an occupant rides in the vehicle, the third user interface may first be provided to the occupant, and thereafter, another different user interface may be provided based on the results of authenticating an occupant and determining the type of occupant. In this case, the third user interface may be an interface that includes input interfaces for performing all of the functions that can be requested by the user. Every user may input a user request for all functions through the third user interface regardless of access authority. The controller 150 may perform a process corresponding to the received user request based on the access authority of the corresponding occupant. That is, in step S21, the third user interface may be provided to each occupant, and the controller 150 may receive a user request inputted through the third user interface.

In step S22, the controller 150 determines whether the received user request is a request for a function that is available only to an authenticated user. For example, a function that is available only to an authenticated user may include an autonomous driving function, an autonomous driving mode switching function.

When a function that is available only to an authenticated user is requested (YES in step S22), the controller 150 performs authentication as to whether the occupant is an authenticated user in step S23. That is, the controller 150 may authenticate whether the occupant is a registered adult occupant. In this case, the registered adult occupant may be an adult who is authorized to control the driving of the vehicle 200. For example, the registered adult may be an authenticated owner of the vehicle, or may be an adult who has been authenticated through a separate authentication process that provides the authority to control the driving of the vehicle.

In step S24, the controller 150 provides a function requested by the authenticated user (YES in step S23). That is, when the authenticated adult occupant requests the autonomous driving start mode or the autonomous driving mode switching function, the controller 150 may perform the requested function without performing a separate approval process. For example, when the autonomous driving start function is requested by the occupant through the user interface, the controller 150 may perform autonomous driving when the occupant is an authenticated adult. In other words, an authenticated adult is capable of performing both the autonomous driving and the manual driving. In the case in which the occupant is an authenticated disabled adult, the controller 150 may perform autonomous driving. In this case, however, the controller 150 may perform autonomous driving only when the area including the starting point and the destination input by the disabled occupant is an area that has been set as an autonomous-driving possible area. In this case, when the vehicle is in an autonomous-driving impossible area, the controller 150 may provide the disabled occupant with a message indicating that the corresponding area is an autonomous-driving impossible area. In addition, when the autonomous driving mode switching function is requested by the occupant through the user interface, the controller 150 may change the driving mode to the autonomous driving mode when the occupant is an authenticated adult. In addition, when the manual driving mode switching function is requested, the controller 150 may change the driving mode to the manual driving mode. However, in the case in which the occupant is an authenticated disabled adult, even when the manual driving mode switching function is requested during autonomous driving, the controller 150 does not change the driving mode to the manual driving mode. In addition, the controller 150 may provide the disabled occupant with a message or warning indicating that the manual driving is impossible for safety.

In addition, when the safety function, such as opening and closing of the window and opening and closing of the door, is requested by the occupant through the user interface, the controller 150 may perform the function requested by the occupant when the occupant is an authenticated adult. However, when the authenticated adult is a disabled person, the controller 150 may provide only select functions depending on the type of disability or the degree of disability.

On the other hand, in step S25, the controller 150 does not perform the function requested by the occupant (NO in step S23). That is, the controller 150 may determine the occupant to be an unauthenticated occupant, and may not perform the function requested by the unauthenticated occupant (the function to which only an authenticated user has access authority). In this case, the controller 150 may provide the unauthenticated occupant with a message or warning indicating that the requested function is unavailable.

In step S26, the controller 150 determines the type of the unauthenticated occupant. The controller 150 determines the category to which the unauthenticated occupant belongs, among a plurality of preset categories. In this case, the unauthenticated occupant may be classified as, for example, an adult, a child, an animal, and a disabled person. A child may be further classified by age, and a disabled person may be further classified by the degree of disability or by whether the disabled person is an adult.

When the unauthenticated occupant is determined to be an adult in step S27-1, the controller 150 provides a first second user interface to the unauthenticated adult occupant in step S28-1. Here, the first second user interface may be an interface that includes a function that an unauthenticated adult occupant is capable of accessing among all of the functions that can be requested by the user.

In step S29-1, the controller 150 performs a process corresponding to the user request inputted through the first second user interface based on the access authority of the unauthenticated adult occupant. For example, when the unauthenticated adult occupant requests the autonomous driving start function or the autonomous driving mode switching function through the first second user interface, the controller 150 may provide a screen or output a warning indicating that the corresponding occupant has no access authority for the requested function. However, when the occupant requests the safety function such as opening and closing of the window and opening and closing of the door through the user interface, the controller 150 may determine that the adult occupant is authorized to access the requested function, and may perform the requested function.

When the unauthenticated occupant is determined to be a child in step S27-2, the controller 150 provides a second second user interface to the child occupant in step S28-2. Here, the second second user interface may be an interface that includes a function that a child occupant is capable of accessing among all of the functions that can be requested by the user.

In step S29-2, the controller 150 performs a process corresponding to the user request inputted through the second second user interface based on the access authority of the unauthenticated child occupant. For example, when the child occupant inputs a user request, the controller 150 may perform a process only for a function that the child occupant is capable of accessing. In addition, the controller 150 may perform a process for a function that the child occupant is capable of accessing after performing an approval process. When the approval process is completed, the controller 150 may perform a process corresponding to the user request on the user interface of the child occupant. When an approval is not granted, the controller 150 may output a warning.

For example, when the child occupant requests the autonomous driving start function through second second user interface, the controller 150 may output a warning sound along with a message indicating that driving is impossible without an adult occupant for safety. In addition, when the child occupant requests the autonomous driving mode switching function or the manual driving mode switching function through the second second user interface, the controller 150 may output a warning sound along with a message indicating that a child occupant is not capable of changing the driving mode for safety. When the child occupant requests the window opening function through the second second user interface, the controller 150 may control the window to be opened down to a predetermined position based on the age or height of the child occupant. In this case, when the window needs to be opened beyond the predetermined position, the controller 150 may operate the window after performing the process of obtaining approval from an adult occupant. In addition, when the child occupant requests the door opening function through the second second user interface and when the child occupant is under a predetermined age, the controller 150 may cause the door to be open after performing the process of obtaining an adult occupant's approval.

In addition, for example, when the child occupant requests playback of multimedia data through the second second user interface, the controller 150 may verify the age limit for content, and may provide only content that is available to the child occupant. In the case in which the corresponding content is not available to the child occupant, the controller 150 may not reproduce the content while outputting the following message: “This content is not available to children under the age of XX”.

When the unauthenticated occupant is determined to be an animal in step S27-3, the controller 150 provides a third second user interface to the animal in step S28-3. Here, the third second user interface may be an interface that includes a function that an animal is capable of accessing among all of the functions that can be requested by the user. However, the process may be set such that none of the programs can be accessed by an animal.

In step S29-3, the controller 150 performs a process corresponding to the user request inputted through the third second user interface based on the access authority of the animal. When the animal inputs a user request through the third second user interface, the controller 150 may output a warning to warn other users.

When the unauthenticated occupant is determined to be a disabled person in step S27-4, the controller 150 provides a fourth second user interface to the unauthenticated disabled occupant in step S28-4. Here, the fourth second user interface may be an interface that includes a function that a disabled occupant is capable of accessing among all of the functions that can be requested by the user.

In step S29-4, the controller 150 performs a process corresponding to the user request inputted through the fourth second user interface based on the access authority of the unauthenticated disabled occupant. For example, when a hearing-impaired occupant requests a navigation function, such as a destination change through the fourth second user interface, the controller 150 may perform the requested function within functions to which the hearing-impaired occupant has access authority. When a visually-impaired occupant requests the navigation function, such as a destination change through the fourth second user interface, the controller 150 may perform an approval process to determine whether the occupant has correctly requested a desired function, and may perform the requested function within functions whereto the visually impaired occupant has access authority. In this case, another adult occupant may perform the approval process through, for example, voice, gesture, or touch, or the visually impaired occupant may perform the approval process through, for example, voice, or gesture.

The above-described embodiments of the present disclosure can be implemented as a computer program that can be executed on a computer using various components, and the computer program can be stored in a computer-readable medium. Examples of the computer-readable media include, but are not limited to: magnetic media such as hard disks, floppy disks, and magnetic tape; optical media such as CD-ROM disks and DVD-ROM disks; magneto-optical media such as floptical disks; and hardware devices that are specially configured to store and execute program codes, such as ROM, RAM, and flash memory devices.

Meanwhile, the computer programs may be those specially designed and constructed for the purposes of the present disclosure or they may be of the kind well known and available to those skilled in the computer software arts. Examples of program code include both machine codes, such as produced by a compiler, and higher level code that may be executed by the computer using an interpreter.

As used in the present disclosure (particularly in the appended claims), the singular forms “a,” “an,” and “the” include both singular and plural references, unless the context clearly states otherwise. Also, it should be understood that any numerical range recited herein is intended to include all sub-ranges subsumed therein (unless expressly indicated otherwise) and accordingly, the disclosed numeral ranges include every individual value between the minimum and maximum values of the numeral ranges.

The order of individual steps in process claims according to the present disclosure does not imply that the steps must be performed in this order; rather, the steps may be performed in any suitable order, unless expressly indicated otherwise. The present disclosure is not necessarily limited to the order of operations given in the description. All examples described herein or the terms indicative thereof (“for example,” etc.) used herein are merely to describe the present disclosure in greater detail. Therefore, it should be understood that the scope of the present disclosure is not limited to the exemplary embodiments described above or by the use of such terms unless limited by the appended claims. Also, it should be apparent to those skilled in the art that various modifications, combinations, and alternations may be made depending on design conditions and factors within the scope of the appended claims or equivalents thereof.

The present disclosure is thus not limited to the example embodiments described above, and rather intended to include the following appended claims, and all modifications, equivalents, and alternatives falling within the spirit and scope of the following claims.

What is claimed is:

1. A method of controlling a user experience (UX) for a vehicle, the method comprising:
monitoring an interior of a vehicle so as to recognize an occupant;
determining a type of occupant;
providing a user interface corresponding to the occupant based on the type of occupant; and
performing a process corresponding to a user request inputted by the occupant through the user interface.

2. The method of claim 1, further comprising:
performing authentication as to whether the occupant is a registered user before the determining a type of occupant;
providing a first user interface to an occupant authenticated as a registered user as a result of performing the authentication; and
performing a process corresponding to a user request inputted by the authenticated occupant through the first user interface,
wherein the first user interface is an interface that provides access to all functions that a user is capable of requesting.

3. The method of claim 2, wherein the determining a type of occupant comprises determining, among a plurality of preset categories, a category to which an unauthenticated occupant belongs,
wherein the providing a user interface comprises providing a second user interface to the unauthenticated occupant based on a category to which the unauthenticated occupant belongs, and
wherein the second user interface is an interface in which functions that an occupant is capable of accessing, among all functions that a user is capable of requesting, are set differently depending on a type of occupant.

4. The method of claim 3, wherein the performing a process corresponding to a user request comprises performing a process corresponding to a user request received through the second user interface, and
wherein the process is a process that is set differently for an identical function depending on a type of occupant.

5. The method of claim 3, wherein the performing a process corresponding to a user request comprises:
determining an access authority as to whether the user request is a user request for performance of a function that the unauthenticated occupant is capable of accessing; and
determining whether to perform the process based on the determined access authority.

6. The method of claim 1, wherein the determining a type of occupant comprises determining at least one of whether the occupant is a human, a gender of the occupant, an age of the occupant, or whether the occupant is disabled, based on at least one of an image of the occupant captured by a camera mounted in an interior of a vehicle, a temperature of the occupant, a voice of the occupant, or a touch range and touch intensity of the occupant on a display, detected by a sensor module.

7. The method of claim 1, wherein the determining a type of occupant comprises:
converting the determined type of occupant into a probability value; and
determining a type of occupant based on a response or reaction of the occupant to content provided based on the probability value.

8. The method of claim 1, further comprising:
recognizing a change in position of the occupant; and
applying a user interface corresponding to a previous position of the occupant to a user interface corresponding to a current position of the occupant in a same manner, based on the current position of the occupant.

9. The method of claim 8, further comprising continuing reproduction of content that has been reproduced before the change in position of the occupant based on the current position of the occupant.

10. The method of claim 1, further comprising, based on whether two or more occupants share a display or whether the determining a type of occupant has been completed:
providing a third user interface to the shared display or to the occupant,
wherein the third user interface is an interface that is provided in a same manner to all occupants.

11. An apparatus for controlling a user experience (UX) for a vehicle, the apparatus comprising:
an occupant recognizer configured to monitor an interior of a vehicle so as to recognize an occupant;
an occupant determiner configured to determine a type of occupant;
an interface provider configured to provide a user interface corresponding to the occupant based on the type of occupant; and
a UX controller configured to perform a process corresponding to a user request inputted by the occupant through the user interface.

12. The apparatus of claim 11, further comprising:
an authentication manager configured to perform authentication as to whether the occupant is a registered user,
wherein the interface provider provides a first user interface to an occupant authenticated as a registered user based on a result of performing the authentication,
wherein the UX controller performs a process corresponding to a user request inputted by the authenticated occupant through the first user interface, and
wherein the first user interface is an interface that provides access to all functions that a user is capable of requesting.

13. The apparatus of claim 12, wherein the occupant determiner determines a category to which an unauthenticated occupant belongs, among a plurality of preset categories,
wherein the interface provider provides a second user interface to the unauthenticated occupant based on a category to which the unauthenticated occupant belongs, and
wherein the second user interface is an interface in which functions that an occupant is capable of accessing, among all functions that a user is capable of requesting, are set differently depending on a type of occupant.

14. The apparatus of claim 13, wherein the UX controller performs a process corresponding to a user request received through the second user interface, and
wherein the process is a process that is set differently for a same function depending on a type of occupant.

15. The apparatus of claim 13, wherein the UX controller determines an access authority concerning whether the user request is a user request for performance of a function that the unauthenticated occupant is capable of accessing, and determines whether to perform the process based on the determined access authority.

16. The apparatus of claim 11, wherein the occupant determiner determines at least one of whether the occupant is a human, a gender of the occupant, an age of the occupant, or whether the occupant is disabled, based on at least one of an image of the occupant captured by a camera mounted in an interior of a vehicle, a temperature of the occupant, a voice of the occupant, or a touch range and touch intensity of the occupant on a display, detected by a sensor module.

17. The apparatus of claim 11, wherein the occupant determiner converts the determined type of occupant into a probability value, and determines a type of occupant based on a response or reaction of the occupant to content provided based on the probability value.

18. The apparatus of claim 11, wherein the occupant recognizer recognizes a change in position of the occupant, and
wherein the interface provider applies a user interface corresponding to a previous position of the occupant to a user interface corresponding to a current position of the occupant in a same manner, based on the current position of the occupant.

19. The apparatus of claim 18, wherein the UX controller continues reproduction of content that has been reproduced before the change in position of the occupant based on the current position of the occupant.

20. The apparatus of claim 12, wherein the UX controller provides, based on whether two or more occupants share a display or whether a type of occupant has been completely determined, a third user interface to the shared display or to the occupant,
wherein the third user interface is an interface that is provided in a same manner to all occupants.
